(19) United States
(12) Patent Application Publication
(10) Pub. No.: US 2025/0388057 A1
(43) Pub. Date: Dec. 25, 2025

(54) Sensor module with environment sensor and air-conditioning device

(71) Applicant: Webasto SE, Stockdorf (DE)

(72) Inventors: Fabian WILL, Stockdorf (DE); Nikolaus LINNER, Stockdorf (DE)

(21) Appl. No.: 19/231,863

(22) Filed: Jun. 9, 2025

(30) Foreign Application Priority Data
Jun. 21, 2024 (DE) 10 2024 117 575.3

(51) Int. Cl. B60H 1/00

(52) U.S. Cl. CPC B60H 1/00271; B60H 2001/003

(57) ABSTRACT

A sensor module for a motor vehicle, which has a carrier element, a see-through area, an environment sensor, which can capture a vehicle environment through the see-through area and which is adjustable relative to the carrier element, and an air-conditioning device. The air-conditioning device has a fan, which is arranged on the carrier element and is aimed at an inflow area of the environment sensor to air-condition the environment sensor.

### CROSS-REFERENCE TO RELATED APPLICATION

This application claims the benefit of DE Application No. 10 2024 117 575.3, filed Jun. 21, 2024, which is incorporated herein by reference in its entirety.

### TECHNICAL FIELD

A sensor module, in particular a roof sensor module (RSM) for a passenger car, which has an environment sensor for capturing a vehicle environment. The invention further relates to a vehicle roof having such a sensor module. The invention also relates to a motor vehicle having such a sensor module and/or such a vehicle roof.

### BACKGROUND

Vehicle roofs are known from practice. A vehicle roof can, for example, be designed as a roof sensor module, which can be placed as a separate structural unit on vehicle bodywork of a passenger car that forms a vehicle bodyshell. As an interface to the vehicle roof, the vehicle bodywork comprises roof spars, which can be designed as longitudinal spars and/or as crossbeams and represent a carrier device on the vehicle bodyshell. The vehicle roof comprises a roof skin, which forms an outer visible surface and has transparent sensor areas, through which the environment sensors which are used to capture a vehicle environment and are arranged under the roof skin are able to capture the vehicle environment.

Autonomous or partly autonomously driving vehicles comprise a roof, for example designed as a sensor roof module or roof sensor module (RSM), which is equipped with a large number of environment sensors. The environment sensors, which are integrated into a dry area in the vehicle roof designed in particular as a roof sensor module and which, for example, are designed as lidar sensors and/or as radar sensors and/or as cameras, capture the environment around the vehicle and provide control electronics of the relevant vehicle with appropriate measured signals, so that a respective traffic situation can be determined and the driving behavior of the relevant vehicle can be adapted to this traffic situation.

A critical aspect of RSM technology is the temperature regulation of the environment sensors, such as lidar sensors, for example, which are integrated in the RSM modules. In order to ensure optimal functionality and durability of the environment sensors, it is essential that these operate within their specified working temperature ranges.

An air-conditioning device has the task of quickly cooling down the environment sensor or a combination of various environment sensors within the RSM from a high temperature level which is considerably above the maximum permissible working temperature of the respective environment sensor to an acceptable level. This is particularly important in environments or operating regions where the external temperature or internal operating conditions can lead to overheating.

In extendable environment sensors, an air-conditioning device is usually arranged directly on the extendable environment sensor. This technology effectively addresses the thermal challenges which are associated with powerful lidar sensors. The cooling or air-conditioning function is normally realized via a housing cooling concept of the environment sensor, in which ambient air is taken in via a fan and conducted to an area of the environment sensor that is to be cooled. Such a fan is mounted directly on the extendable environment sensor and permits an air exchange between the waste heat from the environment sensor and the supply air from the environment, in order thus to cool the environment sensor. An intake area and a discharge area of such fans are separated mechanically from each other in order to avoid recirculation of warm air within the air-conditioning device. The fan outlet of the fan is connected directly to an air outlet from the sensor module. The air inlet of the fan takes in the (external) air around the sensor module. Depending on the module design, because of the limited installation space in the sensor module, only some areas of the environment sensor can receive the airstream, since other regions within the sensor module are occupied by a movement mechanism of the environment sensor and further components of the air-conditioning device. This often very compact design of the sensor module thus offers only little freedom for improved positioning of a fan and associated optimization of an air-conditioning performance.

Even though approaches to air-conditioning devices for air-conditioning environment sensors are already known, there is still potential for further development.

### SUMMARY

It is therefore an object of the invention to provide a sensor module having an improved air-conditioning device.

The object is achieved by a sensor module having the features of Patent claim 1.

Advantageous embodiments of the invention are the subject of the dependent claims. All combinations of at least two features disclosed in the description, the claims and/or the figures fall within the scope of the invention. Here, it goes without saying in particular that usual linguistic transformations and/or a substitution according to the meaning of respective terms within the context of the usual linguistic practice, in particular the use of synonyms supported by the generally recognized linguistic literature, are comprised by the present disclosure content without being mentioned explicitly in their respective formulation.

In a preferred aspect, a sensor module for a motor vehicle is proposed. The sensor module has a carrier element, a see-through area (transparent area), an environment sensor, which can capture a vehicle environment through the see-through area and which is adjustable relative to the carrier element, and an air-conditioning device for air-conditioning the environment sensor. The air-conditioning device has a fan which is arranged and/or fixed on the carrier element, preferably immovably, and is aimed at an inflow area of the environment sensor in order to air-condition or to cool the environment sensor, in particular by causing ambient air and/or external air taken in by the fan to flow to and/or around the environment sensor.

The carrier element can be connected to a part of the bodywork of the motor vehicle that surrounds the sensor module. The environment sensor is adjustable relative to the carrier element at least between a retracted position and an extended position, in which the environment sensor can capture the vehicle environment. Intermediate positions are also possible. The environment sensor is preferably adjustable by a movement mechanism which has at least one drive.

As distinct from the prior art, the fan in the present case no longer has to be placed in a sucking manner on the environment sensor itself but, at least in the extended position of the environment sensor, is arranged on the carrier element at a distance from the sensor. As a result, optimal cooling can be achieved, since the fan can supply the inflow area of the environment sensor with air at high air velocity. A blowing position of the fan directed to the inflow area of the environment sensor has advantages for the heat transfer and thus increases the cooling performance of the air-conditioning device. As distinct from the prior art, the fan no longer has to be placed directly and closely on the environment sensor. Thus, a blowing position of the fan is possible, in which the air-conditioning airstream no longer flows to the environment sensor at only one point. In addition, in the present case it is no longer necessary to lead the airstream in a complicated manner around the environment sensor or around a sensor housing in order to generate the most effective cooling performance. Instead, in the present case simple flow management within the carrier element can be achieved.

In a further aspect, it is proposed that the carrier element be trough-shaped, the environment sensor being adjustable between a retracted position, in which the environment sensor is at least partly accommodated within the trough-shaped carrier element, and at least one extended position, in which the environment sensor projects beyond the trough-shaped carrier element.

The fan is preferably arranged and mounted in the area of a base of the trough of the carrier element. The fan is preferably mounted in the trough, which forms the part of the sensor module that is fixed with respect to the environment sensor. When the environment sensor is in the extended position, there is space and clearance between the fan and the inflow area of the environment sensor, by means of which the air-conditioning performance can be increased, since the inflow area can be supplied more effectively by the fan. If the environment sensor is adjusted, a distance between the fan or a fan discharge side of the fan and the inflow area of the environment sensor is thus increased. The airstream leaving the fan thus has the possibility of spreading out more widely and acting on a larger area of the sensor housing surface. In such a way, the air-conditioning performance of the air-conditioning device and the quantity of heat that can be dissipated are increased. The fan is preferably aligned with the air discharge side toward the inflow area of the environment sensor. The inflow area can be, for example, a portion or region of the sensor housing surface. In the inflow area, thermally conductive elements, such as cooling ribs, can also be provided in order to increase the heat dissipation performance. The extended position is a functional position of the environment sensor in which the environment sensor is to be air-conditioned. The retracted position is a quiescent position of the environment sensor, in which air-conditioning, although preferred and possible, is not functionally relevant.

In a further aspect, it is proposed that the fan be arranged on the carrier element, in particular immovably, in such a way that the fan has an angle of attack relative to the environment sensor in order to supply the inflow area of the environment sensor.

The angle of attack can preferably be determined by a main inflow direction of the fan onto the inflow area of the environment sensor in the extended position of the environment sensor. The fan is therefore preferably mounted at an angle in the carrier element or the trough and aimed at any desired area of the environment sensor. By means of the adjustable environment sensor and the placing of the fan in the carrier element that is stationary relative to the motor vehicle, the distance between the air discharge side of the fan and the environment sensor is increased in constructional terms, at least when the latter is in the extended (functional) position. The fact that the outlet side of the fan is directed at the sensor means that accurate flow management of the airstream is only partially necessary.

In a further aspect, it is proposed that the sensor module have a cover, the air-conditioning device having an air inlet and an air outlet at a distance from the air inlet, wherein the air inlet and/or the air outlet is/are provided on the cover.

The see-through area can preferably be provided on the cover. The air inlet can be provided on the cover, for example in the form of at least one opening. The air outlet can be provided on the cover, for example in the form of at least one opening. Via the air inlet, ambient air can be taken in by the fan and blown onto the inflow area of the environment sensor, in which area the ambient air picks up the (waste) heat from the environment sensor and/or heat introduced into the sensor module from outside. The heated air is then led out of the sensor module into the environment via the air outlet. Within the air-conditioning device, the air inlet is separated from the air outlet in such a way that no recirculation can take place instead, in particular, unidirectional flow management takes place.

In a further aspect, it is proposed that the fan be connected to the air inlet in a flow-conducting manner and be configured to take in ambient air via the air inlet and to discharge it onto the inflow area of the environment sensor.

Therefore, within the air-conditioning device, the air inlet is constructively separated from the air outlet and recirculation of the air within the air-conditioning device is thus not possible. In the present case, the air outlet and the air inlet of the air-conditioning device do not have to be arranged in the slipstream on the rear side of the extendable environment sensor. The air outlet can, for example, also be arranged in a negative-pressure area of the sensor module or of the air-conditioning device, for example in a side area of the cover. As a result, the design freedom in placing the air inlet and the air outlet is increased. Since there is no longer any necessity for complicated air management within the air conditioning device, the entire internal geometry of the air-conditioning device becomes considerably simpler.

In a further aspect, it is proposed that the air inlet and/or the air outlet be adjustable relative to the fan together with the environment sensor.

During the adjustment of the environment sensor, the cover in which the air inlet and the air outlet are arranged is preferably also adjusted since, for example, the environment sensor is mounted on the cover. The flow-carrying connection between the air inlet and the fan is therefore preferably designed in such a way that it can be moved together with the adjustment of the environment sensor but flow management continues to be possible.

In a further aspect, it is proposed that the fan be connected to the air inlet in a flow- conducting manner by a flexible component, in particular by a flexible and/or foldable channel or hose.

Preferably, an intake side of the fan is connected to the air inlet via a foldable, flexible component, for example a channel section or a portion of a hose. The connection is preferably designed in such a way that the ambient air can flow into the air inlet via the component and then be blown out by the fan. An escape of air from the component into the surrounding carrier element is preferably not possible, so that the air taken in can emerge again only after leaving the fan. The air inlet is preferably placed on a rear side or a slipstream side of the extendable environment sensor.

In a further aspect, it is proposed that the carrier element define a wet area of the sensor module, within which the environment sensor and the air-conditioning device are arranged.

The entire internal area of the sensor module, which is preferably delimited by the carrier component, is therefore preferably designed as a wet area.

In the present case, a vehicle roof of a motor vehicle which comprises at least one sensor module according to any desired embodiment is also claimed.

One preferred embodiment of the vehicle roof is designed as a roof sensor module. Such a roof sensor module forms, in an integrated way, a structural unit which accommodates components which are required for the autonomous or partly autonomous driving of the relevant vehicle. The roof sensor module, in which a large number of functional elements can therefore be integrated, thus represents a compact structural unit which is connected by the vehicle manufacturer to vehicle bodywork or a vehicle bodyshell which comprises roof spars, such as roof side spars and/or roof longitudinal spars. The vehicle roof designed as a roof sensor module thus represents a sensor roof module or roof sensor module (RSM), which permits autonomous or partly autonomous driving of the relevant vehicle.

A motor vehicle which is equipped with such a vehicle roof and is designed as an autonomously travelling vehicle travels independently in the autonomous driving mode, at least without substantial interventions by a driver. In a partly autonomous driving mode, the vehicle roof according to the invention forms part of a driver assistance system, for example.

The vehicle roof can be provided with a transparent fixed roof section and/or a roof opening system for a roof opening.

In particular, the vehicle roof at least partly forms a roof of a passenger car. However, it can also be a roof of a commercial vehicle which, for example, is designed as a delivery van, as a bus, as an autonomously travelling minibus such as a so-called people mover, or else as a truck tractor unit.

Also claimed in the present case is a motor vehicle which comprises a sensor module and/or a vehicle roof of the above-described type. The vehicle roof preferably forms a roof sensor module (RSM), which can be arranged on vehicle bodywork of the motor vehicle as a preassembled structural unit. In other words, in particular a vehicle bodyshell of the motor vehicle can therefore be provided with a prefabricated or preassembled roof sensor module which is designed as a sensor roof module or roof sensor module.

It goes without saying that the embodiments and exemplary embodiments mentioned previously and still to be explained below can be formed not only individually but also in any desired combination with one another without departing from the scope of the present invention. It also goes without saying that the embodiments and exemplary embodiments mentioned previously and still to be explained below relate in an equivalent or at least similar way to all embodiments of the invention without each being mentioned separately.

### BRIEF DESCRIPTION OF DRAWINGS

Embodiments of the invention are illustrated schematically in the drawings and will be explained below by way of example.

FIG. 1 shows a schematic illustration of a vehicle roof having a sensor module.

FIG. 2 shows a schematic view of an exemplary embodiment of an air-conditioning device.

FIG. 3 shows a schematic view of an exemplary embodiment of an air-conditioning device

FIG. 4 shows a schematic view of an exemplary embodiment of an air-conditioning device.

### DETAILED DESCRIPTION

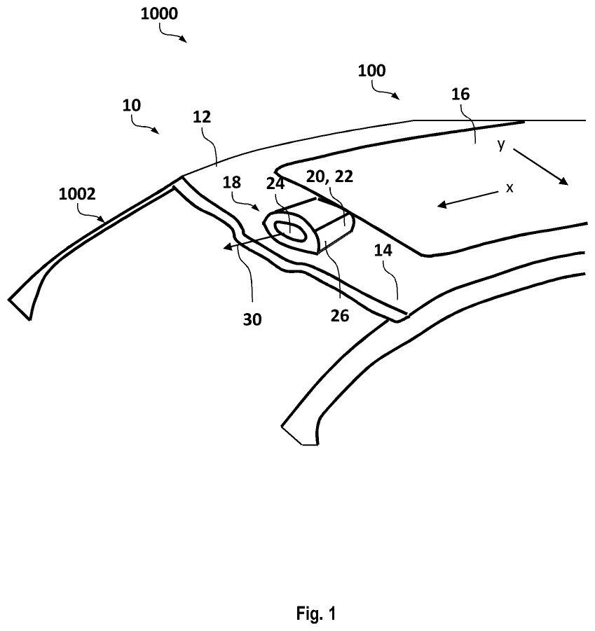

FIG. 1 shows, schematically, a motor vehicle 1000 which has vehicle bodywork 1002. Furthermore, the motor vehicle 1000 has a roof sensor module 10, which is arranged as a structural unit on the vehicle bodywork 1002 and, at least partly forms a vehicle roof 100 of the motor vehicle 1000. The roof sensor module 10 can be provided as a preassembled structural unit.

In alternative embodiments, the vehicle roof 100 can also be a vehicle roof which is not formed as a roof sensor module. Thus, all the embodiments also relate to such a vehicle roof 100.

The roof sensor module 10 comprises a surface component 12 which at least partly forms a roof skin 14 of the vehicle roof 100. The roof sensor module 10 according to FIG. 1 comprises a fixed roof element 16, which forms an at least partly see-through area of the vehicle roof 100. In other or supplementary embodiments, the roof sensor module 10 can have a roof opening system which comprises a cover element that can be displaced for the optional opening or closing of a roof opening.

The roof sensor module 10 or the vehicle roof 100 has a sensor module 18. The sensor module 18 can have a cover 20. Furthermore, the sensor module 18 has at least one environment sensor 22 for capturing a vehicle environment. The environment sensor 22 is configured to capture a vehicle environment via a see-through area 24. The see-through area 24 in the present case is arranged on the cover 20. The environment sensor 22 can be a lidar sensor and/or a camera and/or a radar sensor and/or an ultrasonic sensor and/or a multi-camera sensor. Other sensors are also conceivable.

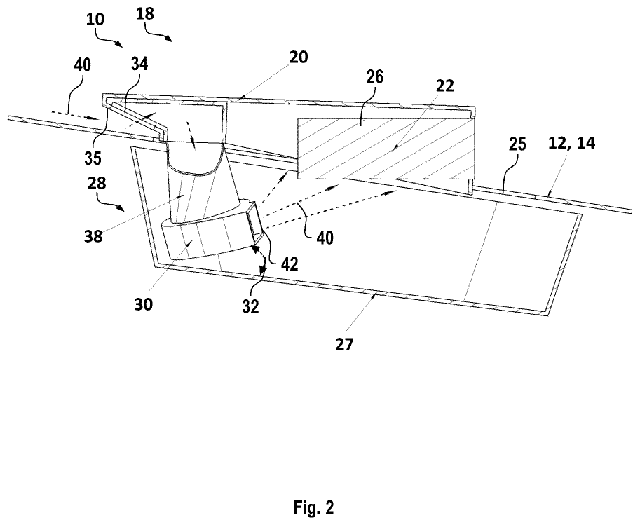

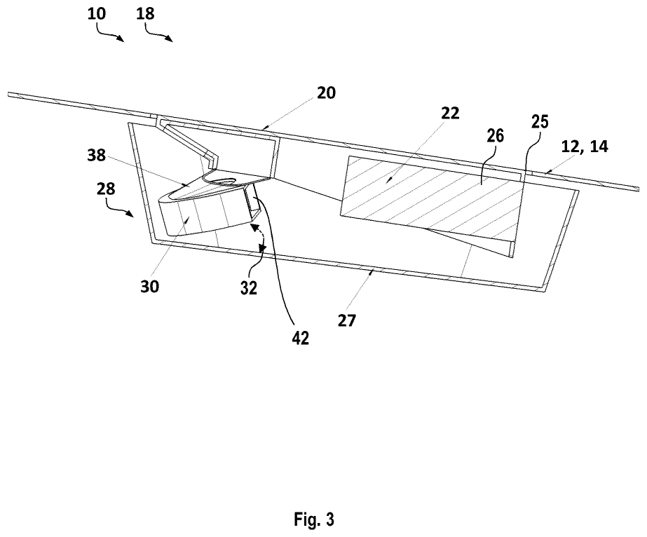

The environment sensor 22 is adjustable by an adjustment mechanism, not specifically shown, between a retracted position (see FIG. 3) and an extended position (see FIG. 2). For this purpose, the environment sensor 22 is arranged in an opening 25 in the surface component 12.

The environment sensor 22 can be arranged in a sensor housing 26. The environment sensor 22 can be arranged underneath the cover 20 or covered by the cover 20. The see-through area 24 can be provided as a window in an opening, not specifically shown, in the cover 20. The see-through area 24 can be provided integrally in the cover 20 or arranged separately in the latter. The see-through area 24 can also be provided in the sensor housing 26.

As can be gathered from FIGS. 2 to 4, the sensor module 18 has an air-conditioning device 28 for air-conditioning the environment sensor 22.

The sensor module further has a carrier element 27 or a carrier component. The carrier element 27 is designed in the form of a trough in the present case. The carrier element 27 therefore forms a module trough, in which the environment sensor 22 is at least partly arranged when in the retracted position (see FIG. 3). The carrier element 27 defines a wet area of the sensor module 18. The environment sensor 22 is adjustable relative to the carrier element 27. In the present case, the carrier element 27 is connected to the surface component 12 or the roof skin 14 but, in other embodiments, can also be connected to a part of the vehicle bodywork 1002. The carrier element 27 preferably surrounds the opening in which the environment sensor 22 is adjustably arranged. In the retracted position, the cover 20 is flush with the surrounding surface component 12 and closes and covers the opening 25.

The air-conditioning device 28 has a fan 30. The fan 30 is arranged on the carrier element 27 and aligned with an inflow area of the environment sensor 22 in order to air-condition the environment sensor 22. The fan 30 is arranged on the carrier element 27 in such a way that the fan 30 has a fixed angle of attack 32 relative to the environment sensor 22, in order to supply the inflow area of the environment sensor 22.

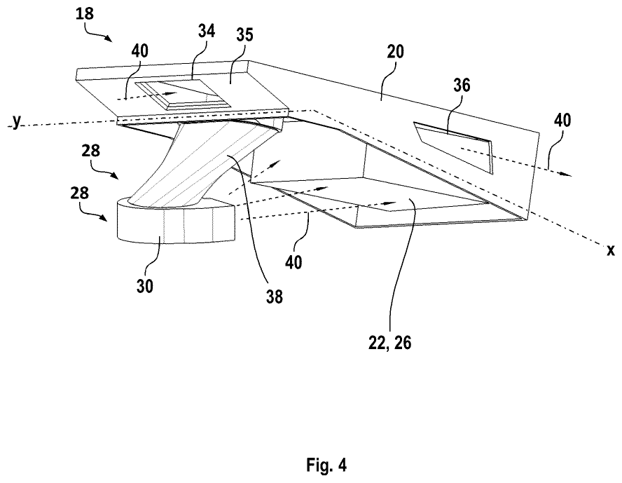

The air-conditioning device 28 also has an air inlet 34 and an air outlet 36 at a distance from the air inlet 34. The air inlet 34 and the air outlet 36 are provided on the cover 20, in each case in the form of openings. The fan 30 is connected in a flow-conducting manner to the air inlet 34 and is configured to take in ambient air via the air inlet 34 and to discharge it onto the inflow area of the environment sensor 22. Since the air inlet 34 and the air outlet 36 are arranged on the adjustable cover 20, they are adjustable relative to the fan 30 together with the environment sensor 22 and the cover 20, so that, in the extended position, a distance between the fan 30 and the air inlet 34 is greater than in the retracted position of the environment sensor. The air inlet 34 is preferably arranged on a slipstream side 35 of the sensor module 18. The air outlet 36 is preferably arranged on the side of the cover 20 (see FIG. 4).

As can be seen from FIGS. 2 to 4, the fan 30 is connected in a flow-conducting manner to the air inlet 34 by a flexibly movable component 38, in particular by a flexibly movable and/or foldable channel or hose. This permits clear flow management within the air-conditioning device 28. If the environment sensor 22 is adjusted, the component 38 can be carried along with it without the flow-carrying connection being interrupted.

As can be seen in particular in FIG. 4, ambient air is taken in through the air inlet 34 by the fan 30. The fan 30 produces an airstream 40 which is taken in via the air inlet 34 and the hose-like component 38. The airstream 40 is then discharged via an air discharge side 42 of the fan 30 in the direction of the inflow area of the environment sensor 22 (see FIG. 2). After supplying the inflow area of the environment sensor 22, the airstream is then conducted out of the sensor module 18 via the air outlet 36.

### LIST OF REFERENCE SYMBOLS

10 Roof sensor module
12 Surface component
14 Roof skin
16 Fixed roof element
18 Sensor module
20 Cover
22 Environment sensor
24 See-through area
25 Opening
26 Sensor housing
27 Carrier element
28 Air-conditioning device
30 Fan
32 Angle of attack
34 Air inlet
35 Slipstream side
36 Air outlet
38 Component
40 Airstream
42 Air discharge side
100 Vehicle roof
1000 Motor vehicle
1002 Vehicle bodywork
x Vehicle longitudinal direction
y Vehicle width direction

1. A sensor module for a motor vehicle, comprising:
a carrier element,
a see-through area,
an environment sensor, which can capture a vehicle environment through the see-through area and which is adjustable relative to the carrier element, and
an air-conditioning device, which has a fan which is arranged on the carrier element and is aimed at an inflow area of the environment sensor to air-condition the environment sensor.

2. The sensor module according to claim 1, wherein the carrier element is trough-shaped and the environment sensor is adjustable between a retracted position, in which the environment sensor is at least partly accommodated within the trough-shaped carrier element, and at least one extended position, in which the environment sensor projects beyond the trough-shaped carrier element.

3. The sensor module according to claim 1, wherein the fan is arranged on the carrier element immovably in such a way that the fan has an angle of attack relative to the environment sensor to supply the inflow area of the environment sensor.

4. The sensor module according to claim 1, wherein the sensor module has a cover, wherein the air-conditioning device has an air inlet and an air outlet at a distance from the air inlet, and wherein the air inlet and/or the air outlet is/are provided on the cover.

5. The sensor module according to claim 4, wherein the fan is connected to the air inlet in a flow-conducting manner and is configured to take in ambient air via the air inlet and to discharge it onto the inflow area of the environment sensor.

6. The sensor module according to claim 4, wherein the air inlet and/or the air outlet is/are adjustable relative to the fan together with the environment sensor.

7. The sensor module according to one of claim 4, wherein the fan is connected to the air inlet in a flow-conducting manner by a flexible component and/or foldable channel or hose.

8. The sensor module according to claim 1, wherein the carrier element defines a wet area of the sensor module, within which the environment sensor and the air-conditioning device are arranged.

9. A vehicle roof of a motor vehicle, comprising at least one sensor module according to claim 1.

10. A motor vehicle, comprising:
a sensor module sensor module for the motor vehicle, comprising:
a carrier element,
a see-through area,
an environment sensor, which can capture a vehicle environment through the see-through area and which is adjustable relative to the carrier element, and
an air-conditioning device, which has a fan which is arranged on the carrier element and is aimed at an inflow area of the environment sensor to air-condition the environment sensor, and/or
a vehicle roof according to claim 9, wherein the vehicle roof forms a roof sensor module, which can be arranged on vehicle bodywork of the motor vehicle as a preassembled structural unit.
